(19) United States
(12) Patent Application Publication
(10) Pub. No.: US 2017/0122269 A1
(43) Pub. Date: May 4, 2017

(54) OXYGEN EXCITATION SYSTEM FOR INCREASING EFFICIENCY AND MINIMIZING POLLUTANTS OF COMBUSTION

(71) Applicant: Eduardo L. COBANKIAT, Paranaque (PH)

(72) Inventor: Eduardo L. COBANKIAT, Paranaque (PH)

(21) Appl. No.: 15/318,348

(22) PCT Filed: Oct. 21, 2014
(86) PCT No.: PCT/PH2014/000019

§ 371 Date: Dec. 12, 2016

(51) Int. Cl. F02M 27/04

(52) U.S. Cl. CPC F02M 27/04

(57) ABSTRACT

An oxygen excitation system for increasing efficiency and minimizing pollutants of combustion is disclosed which comprises a power source, a radio frequency oscillator being in communication to the power source and configured to generate radio frequency, a radio frequency amplifier being in communication to the radio frequency oscillator and configured to amplify the radio frequency generated by said radio frequency oscillator, and an oxygen exciter being in communication to the radio frequency amplifier configured to convert a triplet oxygen into singlet oxygen to maximize fuel efficiency of internal or external combustion engines and minimizing pollutants from exhaust gases.

### TECHNICAL FIELD

This invention relates generally to an oxygen excitation system but more particularly to an oxygen excitation system for increasing combustion efficiency and minimizing pollutants thereof.

### BACKGROUND OF THE INVENTION

Combustion is a high-temperature exothermic chemical reaction between fuel and an oxidant, usually oxygen from atmospheric air that produces oxidized gaseous products in a mixture termed smoke.

Oxidation plays an important role in chemical reaction of fire. Oxidation is the process by which an atom or molecule loses an electron when combined with oxygen. Combustion of hydrocarbons is thought to be initiated by hydrogen atom abstraction from the fuel to oxygen. Lack of oxygen results in noxious and carcinogenic combustion products being emitted as thick black smoke.

Although the majority of substances is completely burned during the course of combustion and is converted to stable oxides, some of the substances are incompletely burned and yield various types of volatile, less-volatile, and nonvolatile products. For example, in incineration, when organic substances, such as ordinary organic compounds, are completely burned, water and carbon dioxides are largely produced. More specifically, when cellulose which is the principal constituent of paper or soybean oil is completely burned, water and carbon dioxides are produced. In contrast, if the cellulose or soybean oil is incompletely burned, various types of unburned substances, e.g., carbon monoxides, aldehyde, and soot are exhausted and a polynuclear aromatic compound, such as pyrene, is produced from the cellulose. Another example is the smoke and exhaust gas from a car or automobile are also known to contain various types of products resulting from incomplete combustion.

Unburned products contain substances deleterious to the global environment or human health. Particularly, toxic substances which are also known as environmental hormone and act as endocrine disturbing chemicals, such as dioxin, are produced in an incinerator as a result of incineration of wastes at insufficient temperatures. Serious environmental pollution caused by such toxic substances has recently been considered a global social problem. All the countries of the world are required to take immediate measures against such pollution.

Oxygen which is contained in air and contributes to ordinary combustion has a multi-electron system in a stable ground state. Air is well known, the ground state of oxygen molecules has a spin quantum number of one and hence corresponds to a multiplet state of spin degeneracy 3. Oxygen molecules in a triplet state (hereinafter referred to as “triplet oxygen”) are stable and are utilized for respiration by creatures. Triplet oxygen molecules are indispensable for sustaining the life of creatures in the planet, including human beings. Through breathing, a human acquires energy by oxidation of constituents of food, such as sugar, lipids, proteins, and the like. An oxidation process associated with generation of biological energy may be deemed a combustion process which proceeds in a very mild manner.

On the other hand, oxygen molecules in a singlet state, i.e., an excited state, (hereinafter referred to as “singlet oxygen”) are highly reactive and have a short chemical life. Therefore, ordinary air contains few singlet oxygen molecules. In a case where triplet oxygen is converted to singlet oxygen in a laboratory, photosensitization utilizing a relevant coloring agent is common. Various reactions by singlet oxygen considerably differ from those by triplet oxygen, and hence products resulting from oxidation of a substance by singlet oxygen also considerably differ from products resulting from oxidation of a substance by triplet oxygen. Singlet oxygen has an energy level of only 22.5 kcal/mol higher than that of triplet oxygen in the ground state and is unstable and highly reactive.

Most fuels, on the other hand, are in a singlet state molecules, which make singlet oxygen quantum mechanically more compatible to interact with most fuels. Combustion process in internal combustion engines in the presence of highly reactive singlet oxygen results into more efficient and complete burning of fuel at temperatures lower than that required for burning it in the presence of triplet oxygen.

Further, in external combustion engines, under the same conditions, a substance to be burned is more efficiently incinerated by singlet oxygen than by triplet oxygen. Hence, it is desirable to convert triplet oxygen into singlet oxygen which referred herein as oxygen excitation to aid in efficient combustion and minimize pollutants in the environment.

Accordingly, to solve the foregoing problem, the present invention provides an excitation system for converting a portion of or substantially all the triplet oxygen molecules involve in combustion into singlet oxygen molecules and induce combustion of fuel and substances to be burned in the presence of singlet oxygen molecules.

It is therefore an object of this invention to provide an oxygen excitation system for increasing combustion efficiency and minimizing pollutants of combustion suitable for both internal and external combustion engines.

Another object of this invention is to provide an oxygen excitation system that efficiently converts triplet oxygen molecules into singlet oxygen molecules by means of amplified radio frequency (RF).

Yet another object of this invention is to provide an oxygen excitation system which aids in minimizing pollutants from exhaust gases, thereby protecting the environment.

Still an object of this invention is to provide an oxygen excitation system that maximizes fuel efficiency during combustion.

Further object of this invention is to provide an oxygen excitation system having simple-designed conductive elements.

The invention discloses an oxygen excitation system for increasing efficiency and minimizing pollutants of combustion which comprises a power source, a radio frequency oscillator being in communication to said power source and configured to generate radio frequency, a radio frequency amplifier being in communication to said radio frequency oscillator and configured to amplify the radio frequency generated by said radio frequency oscillator, and an oxygen exciter being in communication to said radio frequency amplifier configured to convert a triplet oxygen into singlet oxygen, wherein said oxygen exciter being defined by a hollow cylindrical body having an intake portion and an opposing discharge portion configured to be connected to intake manifold of an engine, a conductive elements disposed within said cylindrical body, wherein said conductive elements being defined by a cross-shaped member secured at the intake portion of said cylindrical body, an elongated circular conductor being secured to said cross-shaped member and configured to be concentric with said cylindrical body, a conductive insulation being circumferentially secured inwardly from the edge of the discharge portion of said cylindrical body and a T-shaped member being secured at the discharge portion of said cylindrical body.

### BRIEF DESCRIPTION OF THE DRAWINGS

The above objects and advantages of the invention will become readily apparent to those skilled in the art upon reading the following detailed description of the invention in the light of the accompanying drawing, wherein:

FIG. 1 is the perspective view of the oxygen excitation system for increasing efficiency and minimizing pollutants of combustion according to the present invention;

FIG. 2 is the cross-sectional view taken along line 2-2 of the oxygen exciter according to the present invention; and

FIG. 3 is the schematic diagram of the oxygen excitation system for increasing efficiency and minimizing pollutants of combustion according to the present invention.

### DETAILED DESCRIPTION OF THE INVENTION

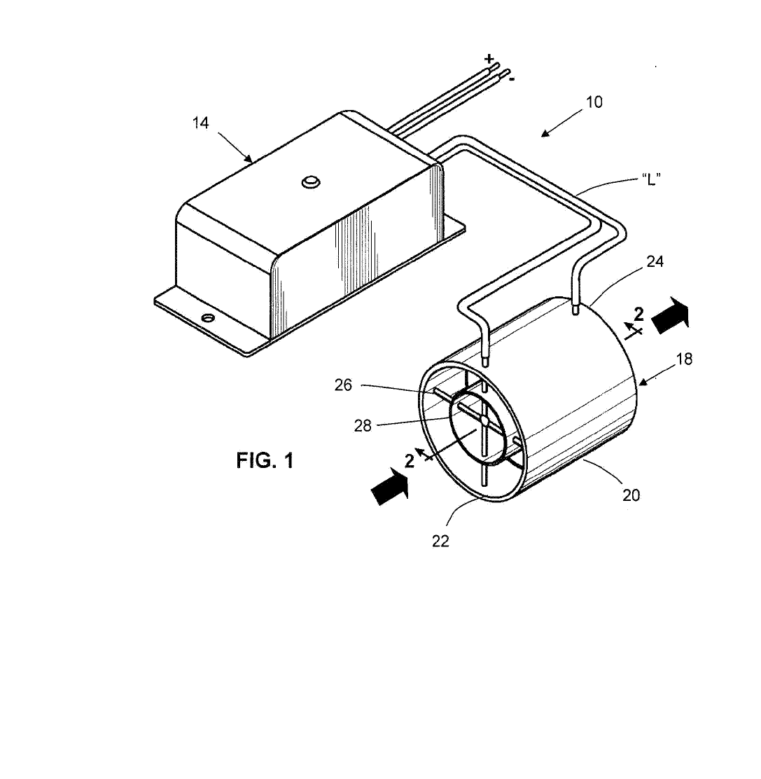

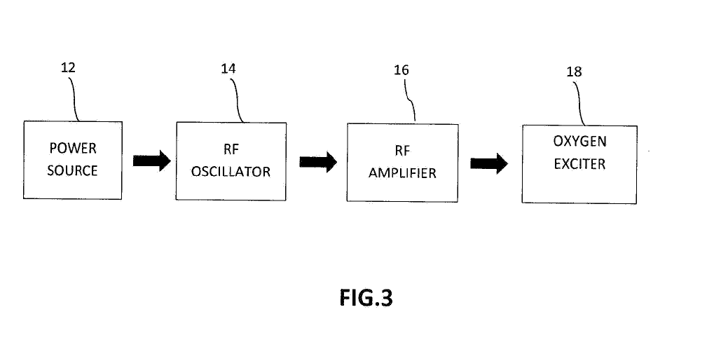

Referring now to the drawings in detail, there is shown in FIGS. 1-3 the oxygen excitation system for increasing efficiency and minimizing pollutants of combustion generally designated as 10. Oxygen excitation system I0 comprises a power source 12 shown in FIG. 3, a radio frequency oscillator 14 being in communication to said power source 12 and configured to generate radio frequency (RF).

System 10 also comprises a radio frequency amplifier 16 as shown in the schematic diagram in FIG. 3 and being in communication with radio frequency oscillator 14 and configured to amplify the RF generated by radio frequency oscillator 14 and an oxygen exciter 18 being in communication to radio frequency amplifier 16 configured to convert a triplet oxygen into singlet oxygen. Radio frequency amplifier 16 is housed inside the radio frequency oscillator 14 in accordance with the invention but can be housed separately therefrom.

As discussed in the background, atmospheric air naturally contains triplet oxygen which is suitable for human consumption particularly in breathing while singlet oxygen is desirable in any combustion process which maximizes fuel efficiency and minimizes pollutants from exhaust gases. Hence, the invention provides an efficient means for converting triplet oxygen into singlet oxygen to be used in combustion. The power source 12, radio frequency oscillator 14, radio frequency amplifier 16 and oxygen exciter 18 are connected by any suitable means known in the art particularly electrical connection line “L”.

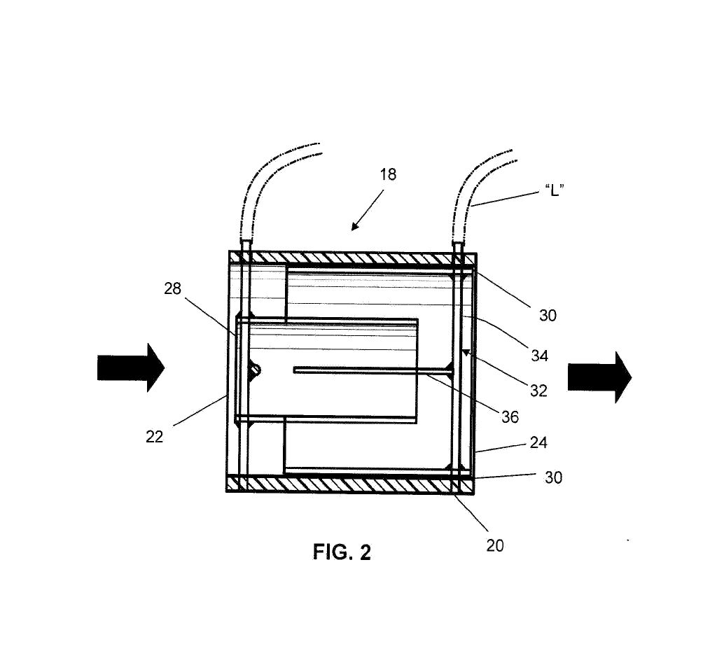

Referring now to FIGS. 1 and 2, oxygen exciter 18 is being defined by a hollow cylindrical body 20 having an intake portion 22 and an opposing discharge portion 24. Cylindrical body 20 is being provided inside with conductive elements designed to maximize oxygen excitation from triplet oxygen to singlet oxygen. Cylindrical body 20 is made of non-conductive material. Discharge portion 24 is configured to be connected to an air intake manifold before air/fuel mixture of an engine, either internal or external combustion.

The conductive elements being made of metal particularly of cathode electrodes configured to discharge the radio frequency electro-magnetic force to the flowing air thereby causing oxygen excitation. The conductive elements comprises a cross-shaped member 26 secured at the intake portion 22 of cylindrical body 20, an elongated circular conductor 28 being secured to cross-shaped member 26 and configured to be concentric with cylindrical body 20. Conductive elements such as cross-shaped member 26 and elongated circular conductor 28 are constructed and fixedly connected with each other generally by means of welding.

Still in FIG. 2, the cylindrical body 20 contains a conductive insulation 30 being circumferentially secured inwardly from the edge of the discharge portion 24 of cylindrical body 20 and a T-shaped member 32 being secured at the discharge portion 24 of cylindrical body 20. T-shaped member 32 is being defined by a first member 34 diametrically secured at discharge portion 24 and a second member 36 projecting inwardly from said first member 34 whereby said first member 34 being in contact with conductive insulation 30 and the second member 36 being substantially disposed inside the circular conductor 28.

The combustion system according to the present invention may in principle be implemented by incorporating a radio frequency oscillator 14 and oxygen exciter 18 into any of various conventional combustion systems. As mentioned above, combustion reaction using singlet oxygen completely differs from combustion reaction using triplet oxygen wherein singlet oxygen being highly reactive and much more desirable in combustion. The oxygen excitation from triplet oxygen molecules to singlet oxygen molecules is diagrammed in FIG. 3 and done by means of power source 12 which is either a DC voltage electrical current from battery or converted from AC power. This electrical power produced by power source 12 is input into the radio frequency oscillator 14 to generate a specific RF operating at range of 50 KHz to 100 MHz. Then, the RF is amplified through radio frequency amplifier 16. The amplified RF is then fed into the oxygen exciter 18. The air that enters the intake portion 22 is subjected to RF electro-magnetic force thereby causing oxygen excitation. Discharge portion 24 is being connected to air intake manifold before the air/fuel mixture chamber.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration such as shape, configuration, material and quantities without departing from the spirit and scope of the invention.

1. An oxygen excitation system for increasing efficiency and minimizing pollutants of combustion comprising:
a power source,
a radio frequency oscillator being in communication to said power source and configured to generate radio frequency,
a radio frequency amplifier being in communication to said radio frequency oscillator and configured to amplify the radio frequency generated by said radio frequency oscillator, and
an oxygen exciter being in communication to said radio frequency amplifier configured to convert a triplet oxygen into singlet oxygen,
wherein said oxygen exciter being defined by a hollow cylindrical body having an intake portion and an opposing discharge portion configured to be connected to air intake manifold of an engine, and a conductive elements disposed within said cylindrical body,
wherein said conductive elements being defined by a cross-shaped member secured at the intake portion of said cylindrical body, an elongated circular conductor being secured to said cross-shaped member and configured to be concentric with said cylindrical body, a conductive insulation being circumferentially secured inwardly from the edge of the discharge portion of said cylindrical body and a T-shaped member being secured at the discharge portion of said cylindrical body.

2. The oxygen excitation system as claimed in claim 1, wherein said T-shaped member being defined by a first member diametrically secured at the discharge portion of said cylindrical body and a second member projecting inwardly from said first member whereby said first member being in contact with said conductive insulation and said second member being substantially disposed inside said circular conductor.

3. The oxygen excitation system as claimed in claim 1, wherein said conductive elements being made of cathode electrodes configured to discharge the radio frequency electro-magnetic force to the flowing air thereby causing oxygen excitation.

4. The oxygen excitation system as claimed in claim 1, wherein said conductive elements being made of metal.

5. The oxygen excitation system as claimed in claim 1, wherein said hollow cylindrical body is made of non-conductive material.

6. The oxygen excitation system as claimed in claim 1, wherein triplet oxygen of air is converted to singlet oxygen, makes oxygen molecules quantum mechanically more compatible to interact with singlet fuel molecules.

7. The oxygen excitation system as claimed in claim 6, will increase fuel efficiency of internal or external combustion engines and minimize pollutants.
